(19) United States
(12) Patent Application Publication
(10) Pub. No.: US 2017/0351989 A1
(43) Pub. Date: Dec. 7, 2017

(54) PROVIDING SUPPLY CHAIN INFORMATION EXTRACTED FROM AN ORDER MANAGEMENT SYSTEM

(71) Applicant: Perfaware, Irving, TX (US)

(72) Inventors: Collin Langdon, Irving, TX (US); Srinivas Hanmandlu, Irving, TX (US); Ranjith Maniyedath, Irving, TX (US)

(21) Appl. No.: 15/173,228

(22) Filed: Jun. 3, 2016

(51) Int. Cl. G06Q 10/06; G06F 17/30

(52) U.S. Cl. CPC G06Q 10/06315; G06F 17/30554; G06F 17/30525; G06F 17/30528

(57) ABSTRACT

Systems and techniques to provide supply chain management information extracted from an order management system are described. A polling configuration file may be loaded and parsed to identify a plurality of polling jobs used to extract data from the order management system. One of the plurality of polling jobs may be assigned to an extraction agent. The extraction agent may query an external data store associated with the order management system to retrieve extracted data and store the extracted data in a queue. Job metadata associated with the polling job may be used to load a mapping. The mapping may be used to transform the extracted data to create transformed data. The transformed data may be displayed based on an associated display template.

### BACKGROUND

A user may use a web browser to navigate to a retailer's website to view items available for purchase via the website, via a store, or both. The website may indicate how many items are in stock at a particular store (e.g., available for the user to purchase from the particular store), how many items are in stock at a warehouse (e.g., available for the user to order for delivery to a specified location), etc. An order management system may provide the inventory information (e.g., how many items are available in a particular store, how many are available at a warehouse, etc.) to the retailer's website. The order management system may receive and process orders when items are purchased online or in a store.

However, the order management system may not be designed to provide information about the supply chain to a business, such as a retailer. For example, the order management system may be unable to provide information as to a current stage of order fulfillment for an order, how many items ordered from the website were delivered on time, how frequently the stock for an item is being replenished at a particular store, or other types of supply-chain related information.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques to provide supply chain management information extracted from an order management system are described. A polling configuration file may be loaded and parsed to identify a plurality of polling jobs used to extract data from the order management system. One of the plurality of polling jobs may be assigned to an extraction agent. The extraction agent may query an external data store associated with the order management system to retrieve extracted data and store the extracted data in a queue. Job metadata associated with the polling job may be used to load a mapping. The mapping may be used to transform the extracted data to create transformed data. The transformed data may be displayed based on an associated display template to provide actionable intelligence and analytics to a business.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating a computing system to provide business data (e.g., supply chain information) according to some examples.

FIG. 2 is a block diagram illustrating a computing system to extract supply chain data from an order management system according to some examples.

FIG. 3 is a block diagram illustrating a computing system that includes a data extraction component according to some examples.

FIG. 4 is a block diagram illustrating a computing system that includes a translation and transformation component according to some examples.

FIG. 5 is a block diagram illustrating a computing system that includes a job server component according to some examples.

FIG. 6 is a block diagram illustrating a computing system that includes an alerting component according to some examples.

FIG. 7 is a block diagram illustrating a computing system that includes a search component according to some examples.

FIG. 8 is a flowchart of a process that includes extracting data from an order management system according to some examples.

FIG. 9 is a flowchart of a process that includes receiving a query according to some examples.

FIG. 10 illustrates an example configuration of a computing device that can be used to implement the systems and techniques described herein.

### DETAILED DESCRIPTION

Systems and techniques are described herein to extract, transform, and load (ETL) data from an order management system to provide a retailer's (or other type of business) business analysts, support, engineer, and operations teams with information that the order management system does not readily provide, such as supply chain information, real time statistics and analytics, visualization, reporting, and enterprise system health. For example, the systems and techniques may provide the retailer with reports (e.g., how many items ordered from the website were delivered on time, how frequently the stock for an item is being replenished at each store, etc.) and respond to queries (e.g., what is a current stage of order fulfillment for an order, etc.). The system and techniques may provide the retailer with the ability to view and query information about the supply chain (e.g., should a particular item be procured, should stock of a particular item be replenished, etc.).

The data used to create reports or respond to queries may be stored in the order management system. Without the systems and techniques described herein, a software engineer writing software code and/or complex structure query language (SQL) queries may require time (e.g., several hours, or even days) to extract the same information. The systems and techniques provide a user interface to enable the retailer to view and query, substantially in real time, information about the supply chain. For example, a retailer can use the systems and techniques to obtain, substantially in real-time, information about orders, items, overall supply chain issues, etc. The systems and techniques provide a user interface displaying the overall system health of the Order Management and Inventory Management Systems and underlying infrastructure, such as service response times, memory and CPU usage enterprise wide. The systems and techniques may extract data from an order management system, translate the data to create translated data, and load the translated data into a system, e.g., a business data provider system, to enable a retailer to view and query the translated and extracted data.

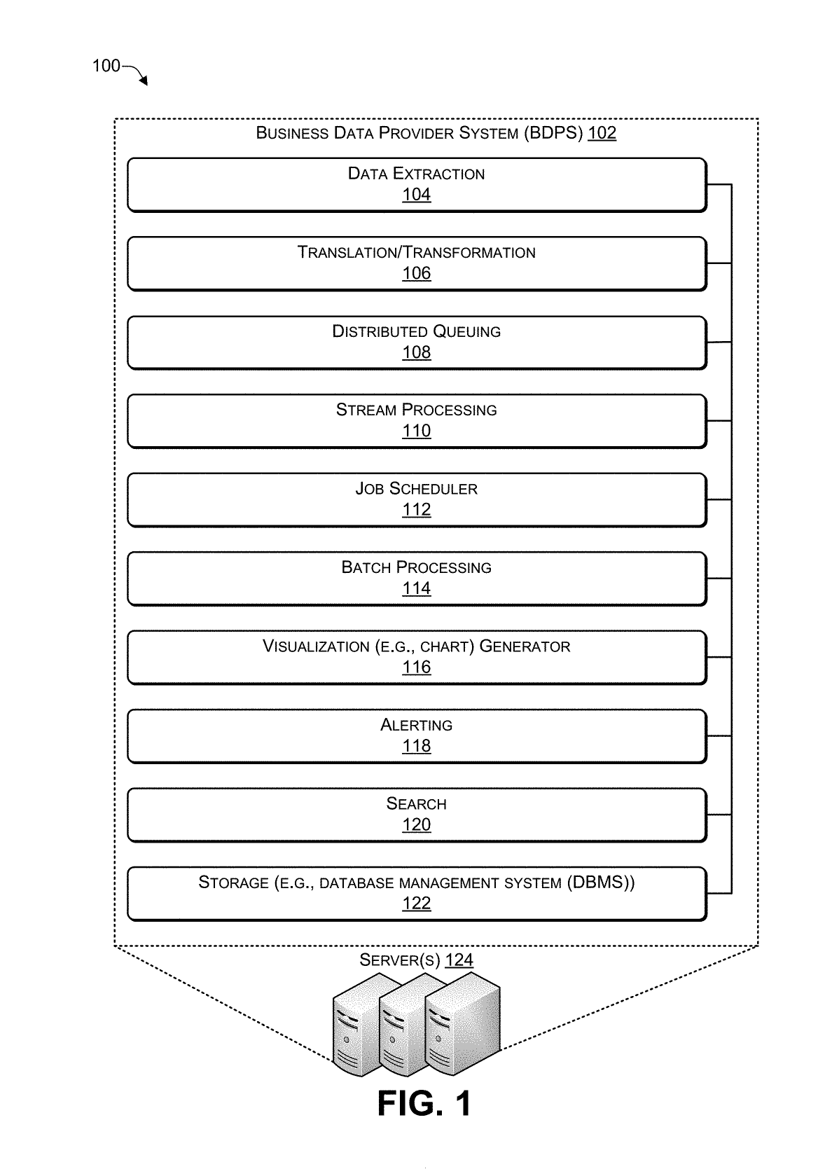

FIG. 1 is a block diagram illustrating a computing system 100 to provide business data (e.g., supply chain information) according to some examples. The computing system 100 may include a business data provider system (BDPS) 102 to extract, transform, and load data from an order management system (e.g., such as IBM® Sterling Commerce® or similar) to enable a retailer to view and query information, such as supply-chain information. The BDPS 102 may include multiple modular components, such as data extraction 104, translation/transformation 106, distributed queueing 108, stream processing 110, job server 112, batch processing 114, visualization 116, alerting 118, search 120, and storage 122. The BDPS 102 may execute on one or more servers 124 that may be located at a customer's premises or at a remote facility (e.g., the customer's facility or a third party cloud-based facility).

The data extraction component 104 may be used to connect to one or more external systems, such as an order management system. The external system(s) may include a database, may be event driven, may provide a web service, and may use one or more types of data formats. The BDPS 102 may include software code to extract data from any system and transform the data into a standardized format for use by the BDPS 102. For example, the data extraction component 104 may be capable of extracting order information, e.g., line by line, from an order management system. The data extraction component 104 may be capable of extracting information from event logs. For example, the data extraction component 104 may listen for new event logs. When the data extraction component 104 determines that new event log(s) have been generated, the data extraction component 104 may extract information from one or more fields of the event log(s) and store the information in appropriate places in the BDPS 102.

The translation/transformation component 106 may translate different types of data into a standardized format that is used internally by the BDPS 102 to store, retrieve, and view data. Thus, ETL (e.g., performed by the components 104, 106) may be used to extract data from external systems, transform the data into a standardized format, store the data in the BDPS 102.

The distributed queueing component 108 may include multiple nodes with access to multiple shared partitions. The distributed queueing component 108 may behave as a write ahead log queue that stores a log (e.g., an event log from an order management system) in a queue and then flushes the log out of the queue at a later time based on various factors. The distributed queueing component 108 may store a log long enough to enable the translation/transformation component 106 to translate the log into useful information by extracting information from the log. After the information has been extracted from the log, the log may be removed (e.g., flushed) from the queue and stored in a database. Thus, the log may be used as an intermediate place where data, such as event logs, may be stored. Any of the components of the BDPS 102 may access data (e.g., event logs) stored in the queue because the data is raw and unprocessed. Typically, data (e.g., event logs) may be stored for N days (where N>0), such as seven days. Data, such as event logs, may be extracted (e.g., pulled) from an external system (e.g., an order management system) substantially in real time, and stored (e.g., pushed) into the queue.

The visualization generator 116 may pull the data from the queue (e.g., substantially in real time) and present the data visually (e.g., one or more charts) on a display device. Thus, if a user desires to see the health of the system, the user may look at the one or more charts that are being updated substantially in real time (e.g., typically 30 seconds or less from the time the event log was generated by the external system, such as the order management system).

The data gathered from the external system and stored in the queue may flow through the stream processing component 110. The stream processing component 110 may be a distributed platform that can scale horizontally and uses a functional programming paradigm, e.g., given a particular set of inputs, a function will process the set of inputs, resulting in a same (e.g., expected) set of outputs. The stream processing component 110 may be used to aggregate (e.g., consolidate) data and create statistics with the data, substantially in real time. For example, when an order management system receives an online order, the order may be processed to deliver one or more items to the customer. The BDPS 102 may extract order processing data from the order management system to determine a time to complete an order, e.g., from the time the order was created to the time that the product(s) in the order were delivered. The stream processing component 110 may keep the order processing information in memory, e.g., from a first event (e.g., order created) to a last event (e.g., products delivered). The stream processing component 110 may determine how long it took for the order to be processed based on the events, such as the first event to the last event. The stream processing component 110 may be used to aggregate information, such as how many orders of a particular item are received, when (e.g., what times of the day) the orders are being received, how much money is being made from the orders, substantially in real time. In this example, the stream processing component 110 may use a time window within which to collect events associated with the particular item. The stream processing component 110 and the data extraction 104 may be used to perform distributed queuing of the events collected in the time window.

The job scheduler component 112 may schedule batch processing jobs for the batch processing component 114 to process. For example, the job scheduler component 112 may route and schedule jobs in which multiple data items are processed as a batch to the batch processing component 114.

The visualization generator 116 may pull, substantially in real time, data from the queue maintained by the distributed queuing component 108 and visually display the data, e.g., using one or more charts. The altering component 118 may pull, substantially in real time, data from the queue maintained by the distributed queuing component 108, determine whether the data indicates an event for which an alert is to be generated, and generate an alert when the data satisfies a rule defined by a user. For example, the data may include an event log indicating a particular event, e.g., the inventory level for a particular item has fallen below a particular level. To illustrate, a user may create a rule to generate an alert whenever inventory levels for a particular item fall below N items or N% (e.g., N>0). Based on the settings, the alerting component 118 may generate an alert whenever the rules to generate an alert have been satisfied. The rules determining when an alert may be complex, e.g., generate an alert when an inventory level for a particular item is (1) below a threshold amount in all warehouses and (2) below a threshold amount in all stores.

The search component 120 may enable a user to perform a search of data stored by the BDPS 102. For example, the search component 120 may enable a user to perform a keyword search, where the keyword(s) includes a shipment identifier, a store number, or other type of keyword(s). The search component 120 may use a pattern matching algorithm to identify data (e.g., event logs) that include the keyword(s).

The storage component 122 may be used to store data that was extracted from an external system (e.g., an order management system) and translated (e.g., transformed) into a standardized format used by the BDPS 102.

Thus, a BDPS 102 may extract, transform, and load data from an external system, such as an order management system. The BDPS 102 may enable a user to view and query, substantially in real time, information about the supply chain. The supply chain information may not be readily accessible using a user interface provided by the order management system. The BDPS 102 may extract and transform data from the order management system to provide a user with information (e.g., supply-chain related information) that the order management system is not capable of providing.

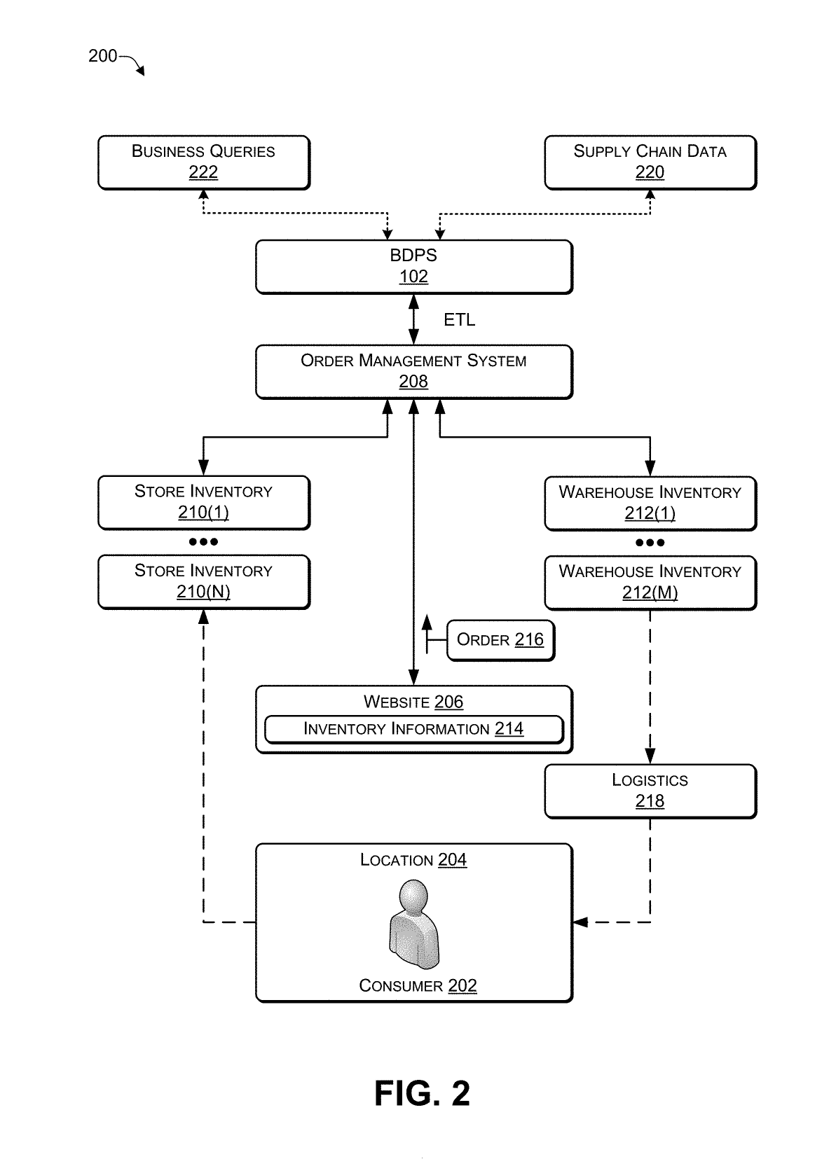

FIG. 2 is a block diagram illustrating a computing system 200 to extract supply chain data from an order management system according to some examples. A consumer 202 at a location 204 may view a website 206 that includes a catalog of items available for acquisition (e.g., lease, purchase, etc.). An order management system 208 (e.g., IBM® Sterling Commerce®) may provide the consumer 202 with information, substantially in real time, regarding the availability of items available for acquisition. For example, the order management system 208 may determine store inventories 210(1) to 210(N) associated with N stores (N>0) where the consumer 202 can go to acquire one or more items. The order management system 208 may determine warehouse inventories 212(1) to 212(M) associated with M warehouses (M>0, M may not be equal to N). The order management system 208 may provide inventory information 214 associated with the store inventories 210, the warehouse inventories 212, or both to the website 206 to enable the consumer 202 to determine whether to travel to a store that has particular items in inventory or whether to order the particular items online for delivery to the location 204.

If one of the store inventories 210 (e.g., of a store closest to the location 204) has one or more items in stock, the consumer 202 may travel to the store, and acquire the items. The corresponding one of the store inventories 210 may be updated and the updated inventory information may be provided to the order management system 208. The order management system 208 may update the inventory information 214 displayed on the website 206.

The consumer 202 may place an order 216 to acquire the one or more items. The order management system 208 may receive the order 216, determine a closest warehouse having an inventory of individual items of the items in the order 216 and instruct the warehouse to ship the item(s) using logistics 218 (e.g., postal service, courier service, etc.) to the location 204. In some cases, if one of the warehouse inventories 212 does not include all of the items in the order 216, the order management system 208 may split the order 216 such that the items in the order 216 may be sent to the consumer 202 from more than one warehouse. The corresponding warehouse inventories 212 may be updated after the items in the order 216 have been shipped and the updated inventory information may be provided to the order management system 208. The order management system 208 may update the inventory information 214 displayed on the website 206.

The BDPS 102 may extract data from the order management system 208 and display supply chain data 220 that is updated, substantially in real time. The BDPS 102 may receive and respond to business queries 222, such as how many of a particular item are in stock in the store inventories 210 and in the warehouse inventories 212, etc.

Thus, the BDPS 102 may enable a business, such as a retailer, to view the supply chain data 220 and to query the BDPS 102 to retrieve information from the supply chain data 220.

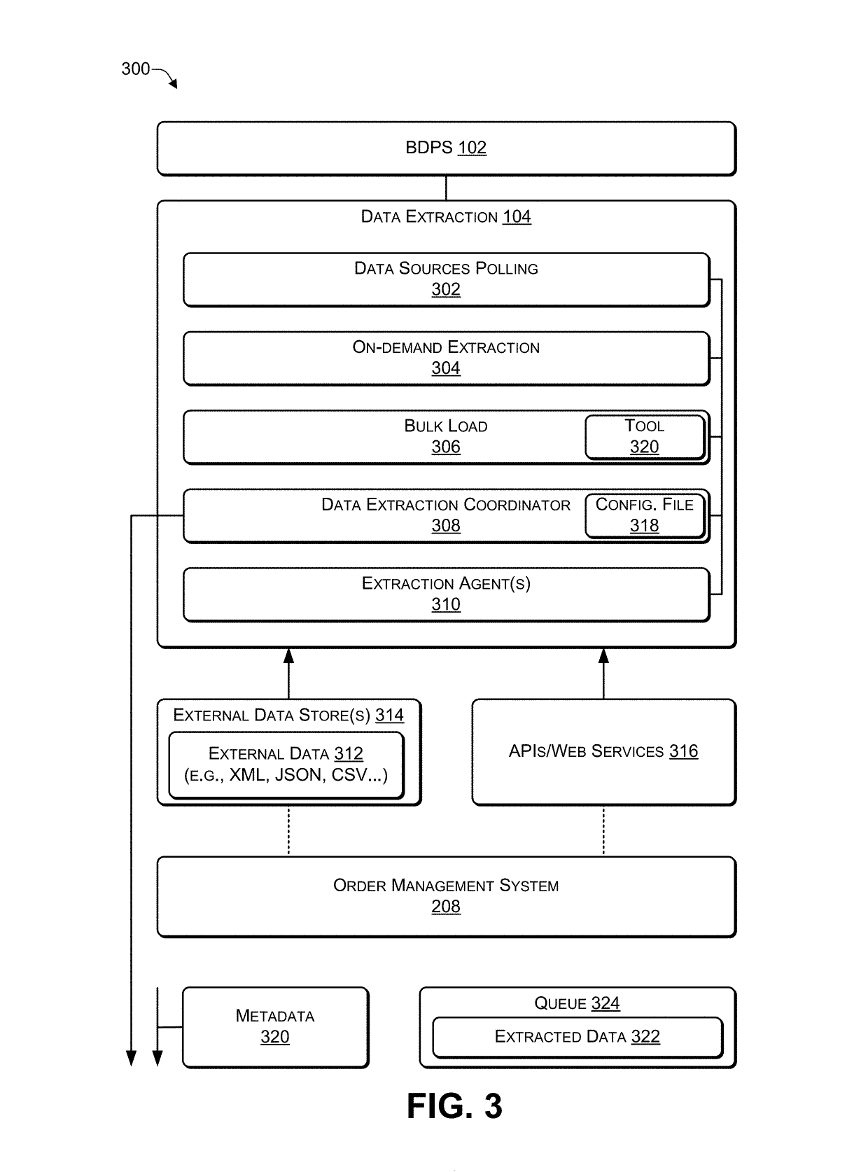

FIG. 3 is a block diagram illustrating a computing system 300 that includes a data extraction component according to some examples. The data extraction component 104 may include a data sources polling component 302, an on-demand extraction component 304, a bulk load component 306, a data extraction coordinator 308, and one or more extraction agents 310. The data sources polling component 302 may instruct one or more of the extraction agents 310 to periodically (e.g., at a predetermined time interval) extract particular types of data from the order management system 208. For example, a user (e.g., an administrator or super user) may desire to load data from a pre-defined (or user-defined) data source and perform particular post-processing for visualization and analysis. The user may log into an administration graphical user interface (GUI) and select “data extraction.” In response, the GUI may present the user with one or more data source presets as well as an option to create a new data source preset.

The on-demand extraction component 304 may instruct one or more of the extraction agents 310 to extract data from the order management system 208 in response to a user request or in response to a rule. For example, a user may query the status of a particular order or an inventory level of a particular item. If the information to answer the query is not available (e.g., in the BDPS 102 of FIG. 1), then the on-demand extraction component 304 may instruct one or more of the extraction agents 310 to extract the appropriate data used to answer the query. As another example, if an inventory level of a particular item in a store falls below a threshold amount, a rule may cause the on-demand extraction component 304 to instruct one or more of the extraction agents 310 to extract an inventory level of the same item at a nearby store. In this way, the retailer may transfer inventory of the item from the nearby store to the store with low inventory.

The data extraction coordinator 308 may schedule when the extraction agents 310 extract data from an external system, such as the order management system 208. The extractions agents 310 may extract data, such as external data 312 from one or more external data stores 314. The external data 312 may include data in an extended markup language (XML) format, data in Java script Object Notation (JSON), comma-separated values (CSV), system logs format, or any combination thereof. The extractions agents 310 may extract data, such as the external data 312, from one or more application programming interfaces (APIs), web services (or both) 316. The data extraction coordinator 308 may load a polling configuration file 318 upon startup or in response to a user instruction. The polling configuration file 318 may include locations in an external system from which to extract data, when to extract the data, how often to extract the data, which extraction agents are to operate substantially in parallel (e.g., to avoid inventory mismatches etc.), how to verify the integrity of extracted data, etc.

The bulk load component 306 may be used to handle when a large quantity or time range of data is to be extracted for the purpose of historical analytics such as trend and anomaly detection and comparisons to current data. The extraction may take a longer time than the polling extractor which is why the bulk load component may be implemented as a separate entity. The bulk load component 306 may use the data extraction coordinator 308 to schedule for processing the large quantity of extracted data. The data extraction agents 310 may parse and extract information from extracted data, e.g., by going through the data line by line and identifying relevant information, extracting the information, and translating or transforming the information. The bulk loader use case is typically used with historical data, e.g., data older than the current day and usually spanning one or more days in duration. For example, a business analyst may desire to compare sales numbers of a particular type of order from last year to the current day's performance. The entire last year of the particular type of order may be queried from the order database, with the extraction agents extracting the relevant fields, and sending the extracted fields to stream processing for aggregation. The polling extraction job may be set up to determine the current day's sales numbers for the particular type of order. In this way, the business analyst can compare today's results with a historical trend chart by instructing the visualization component to create the chart.

The data extraction agents 310 may have the knowledge as to from where to extract data in the order management system 208, how to extract the data, the data format associated with each type of data, data mappings, etc. For example, the extraction agents 310 may know that order information can be obtained from a first location (e.g., order database) of the order management system 208, inventory information can be obtained from a second location (e.g., inventory database). The extraction agents 310 may know the data format of data stored in the order management system 208 and how to extract the information, such as which fields of an event log or database item include particular information.

The data extraction component 104 may use a Hadoop® distributed file system (HDFS) or similar file system for distributed storage and distributed processing of very large data sets. After data is extracted from the order management system 208, extracted data 322 may be stored in a queue 324. The data extraction coordinator 308 may send metadata 320 (e.g., queue identifier etc.) associated with the extracted data 322 stored in the queue 324 to the translation/transformation component 106 to enable the extracted data 322 to be translated and/or transformed.

The data extraction component 104 may use at least three different techniques to load data into the BDPS 102, including scheduled polling, on demand extraction, and bulk load (e.g., of historical data).

### Scheduled Polling

In scheduled polling, the data extraction coordinator 308 may load contents of the polling configuration file 318 (e.g., from disk into memory) under certain conditions, such as on initial startup or in response to a user instruction. The polling configuration file 318 may include information associated with a set (e.g., list) of polling jobs to be assigned to the extraction agents 310. For example, for each polling job (e.g., task), the polling configuration file 318 may include data access object (DAO) information, scheduling information, and job metadata. The DAO information may include (a) instructions on how to access data in the order management system 208 and external data stores 314, (b) access credentials (or access keys) to access data in the order management system 208 and external data stores 314, (c) information on how to create a query to extract the data, and (d) a format associated with the data to enable relevant data to be extracted. The scheduling information may include when and how often to poll the data. The job metadata may include which mappings (e.g., transformation mapping and/or translation mapping) to use after the data has been extracted, and a message topic (e.g., Apache Kafka topic) to associate with the extracted data.

The data extraction component 104 may parse the polling configuration file 318 and then pass instructions associated with the polling jobs to the extraction agents 310. The instructions may include a time and a frequency at which to perform the polling, a reference to a DAO (e.g., instructions on how to access the data), parallelism between agents (e.g., which agents are to operate substantially in parallel to provide accurate data), and check pointing and data integrity control.

The extraction agents 310 may poll (e.g., query) the order management system 208 and external data stores 314 and encapsulate the results (effectively serializing the results) into a data transfer object (DTO) that is stored in the in-memory queue 324 as the extracted data 322. The DTO may comprise an object that carries data between processes to avoid inter-process communication using remote interfaces (e.g. web services). The DTO may aggregate data that would have been transferred by several calls to remote interfaces, making inter-process data transfer more efficient. After each of the extraction agents 310 have completed their polling jobs, each extraction agent may send a job completion report to the data extraction coordinator 308 indicating whether the polling job was successful and if unsuccessful, what errors were encountered.

The data extraction coordinator 308 may pass the job information metadata 320 to the translation/transformation component 106. The metadata 320 may include a job identifier (e.g., identifying which job extracted the data), an endpoint, which transformation mapping and which translation mapping(s) to use with the extracted data, a number of lines of data that were extracted, and a queue identifier (e.g., identifying where in the queue 424 the extracted data 422 is stored).

### On-Demand Extraction

The on-demand extraction component 308 may enable an administrator (or super user) to load data from a pre-defined (or user-defined) data source into the BDPS 102 and perform post-processing for visualization and analysis. For example, a user (e.g., an administrator or super user) may log into an administration graphical user interface (GUI) and select “data extraction.” The GUI may display preset data source options as well as an option to create a new data source preset.

If the user elects to create a new data source preset (e.g., a new data extraction module) the user may be asked to create a data access object (DAO), specify extraction commands to extract the data (e.g., a structured query language (SQL) query or other type of extraction commands), specify a translation schema to translate the extracted data, specify a transformation schema to transform the extracted data, specify an output format for the extracted data, specify a time at which to perform the data extraction, specify how frequently to perform the data extraction, specify whether to bulk load historical data (e.g., data older than N days, where N>0), and specify any other information on how and when the data is to be extracted. When creating the DAO, the user may specify a protocol used to extract the data, a driver used to extract the data, a location (e.g., universal resource locator (URL), SQL connection descriptor, or other location descriptor) from which the data may be extracted, credentials to use when extracting the data, a schema associated with the data to be extracted, and other information related to accessing the external data. Any data that is a one month or older may be treated as historical data. After the user has provided information about the new data source preset, the user may submit a request to create the new data source preset. For example, the request may be handled internally using extended markup language (XML) submitted via the user's interaction in the User Interface (UI), or posted to directly using the Data Extraction API.

After the user selects either a predefined data source preset or a newly created data source preset, the GUI may send a request to the data extraction coordinator 308. The data extraction coordinator 308 may parse the request (e.g., in XML) and assign polling jobs to one or more of the extraction agents 310. The extraction agents 310 may perform the polling jobs, extract data, and send a message to the data extraction coordinator 308 when the polling jobs have been completed. The data extraction coordinator 308 may pass the job information metadata 320 to the translation/transformation component 106, where mappings may be loaded from the mapping repository using the mapping identifiers in the metadata and translation agents and transformation agents may be instructed to apply the mappings. Upon completion the translation and transformation agents may write out to a specified Kafka Topic in the distributed queueing component 108. Jobs that are to be repeated may be written to the polling configuration file 318 and invoked based on a master schedule used by the data extraction coordinator 308.

### Bulk Loading

The bulk load component 306 may be used to load a large quantity of data, such as historical data (e.g., typically older than N days, such as data that is at least one month old). For example, a user may load several years of order creation information and shipping information associated with particular products or particular locations to perform trend analysis, anomaly detection, and other analysis. For example, a user may login to the administration GUI and select “bulk load.” The data extraction coordinator 308 may be sent a bulk load request (e.g., in XML format). The data extraction coordinator 308 may parse the bulk load request and use a bulk data transfer tool 320 (e.g., Apache Sqoop™ connector). The bulk data transfer tool 320 may be used to transfer data from structured data stores (e.g., relational databases) and may support incremental loading of tables and free form SQL queries as well as saved jobs which can be run multiple times to import updates made to a database since a last import. The bulk data transfer tool 320 may create a Hadoop distributed file system (HDFS) context and leverage a Hadoop framework to initiate extraction of historical data from the data source. The data extraction coordinator 308 may act as a liaison to the bulk data transfer tool 320 and report the progress of the bulk data transfer via the UI. The data transformation coordinator 402 assign one or more of the agents 404, 406 to translate and/or transform the bulk data. The agents 404, 406 may write the translated data 410 and the transformed data 412 to the distributed queueing component 108 (e.g., Kafka™ topic).

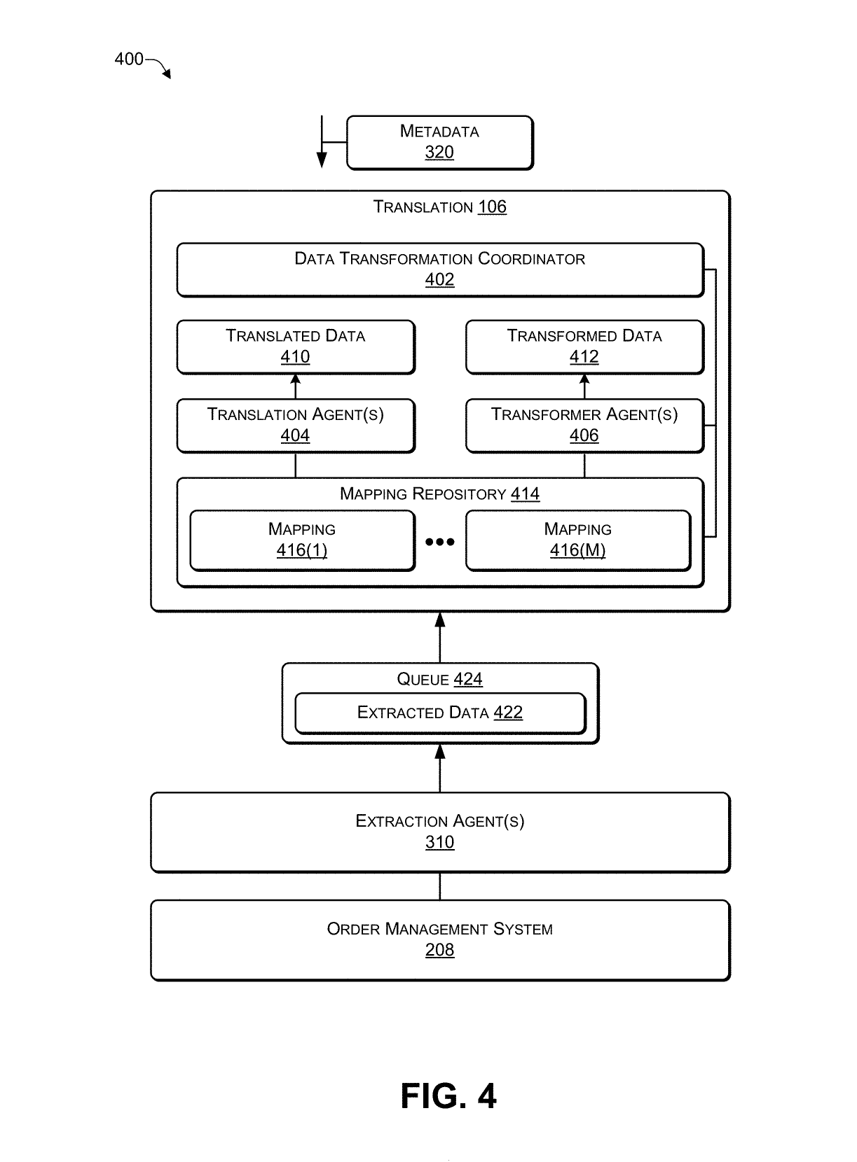

FIG. 4 is a block diagram illustrating a computing system 400 that includes a translation and transformation component according to some examples. The translation/transformation component 106 may take data extracted from the order management system 208 and translate the data, transform the data, or both.

The translation/transformation component 106 may include a data transformation coordinator 402 to coordinate the activities of multiple translations agents 404 and multiple transformer agents 406. The data transformation coordinator 402 may receive the metadata 320 from the data extraction coordinator 308 of FIG. 3. The metadata 320 may identify where the extracted data 322 is stored in the queue 324. The translation agents 404 may translate the extracted data 322 from one format to another format to create translated data 410. The transformer agents 406 may transform the extracted data 322 to create transformed data 412. The translated data 410 and the transformed data 412 may use a format that is usable by the BDPS 102 to provide supply chain information. The data transformation coordinator 402 may handle communications with the agents 404, 406, including assigning and scheduling the work performed by the agents 404, 406. The multiple agents 404, 406 may enable scalability. For example, one transformation agent may be used with a first portion of the order management system 208 that generates a small volume of data, while three or more transformation agents may be used with a second portion that generates ten times the volume as the first portion. Each of the agents 310, 404, and 406 may be implemented as a JAVA process.

A mapping repository 414 may include mapping information, e.g., a mapping 416(1) to a mapping 416(M) (M>0), with each of the mappings 416 describing how different types of the extracted data 322 are formatted in the order management system 208 and how the fields in the extracted data 322 map to the translated data 410 or the transformed data 412. For example, one of the mappings 416 may indicate the fields in an order in the extracted data 322 from the order management system 208, e.g., a first field includes a date at which the order was placed, a second field includes the items included in the order, a third field includes payment information, a fourth field includes a delivery address, and the like.

The data transformation coordinator 402 may use the job metadata 320 to identify which of the mappings to load from the mapping repository 414 and instruct the agents 404, 406 to perform the appropriate translations and/or transformations.

After the agents 404, 406 use the mappings to translate and/or transform the extracted data 422, the agents may write out a particular message topic (e.g., Apache Kafka Topic) to the distributed queuing component 108. The distributed queuing component 108 may assign message identifiers to each message and distribute the messages to other components.

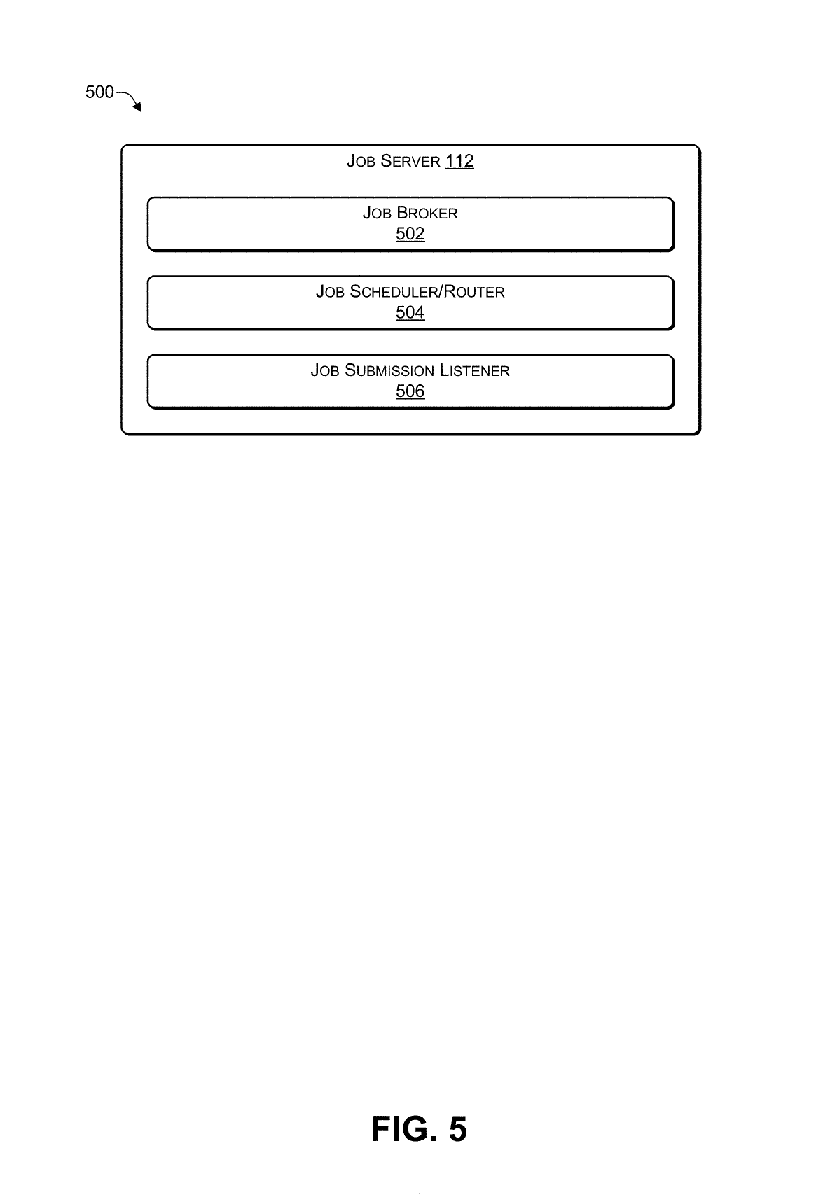

FIG. 5 is a block diagram illustrating a computing system 500 that includes a job server component according to some examples. The job server component 112 may include a job broker 502, a job scheduler/router 504, and a job submission listener 506. The job submission listener 506 may listen for jobs submitted by other processes (e.g., agents). The job broker 502 may identify the type of job to be performed and instruct the job scheduler/router 504 where to route the job. The job scheduler/router 504 may route and schedule a job based on the type of job to be performed, in accordance with instructions provided by the job broker 502.

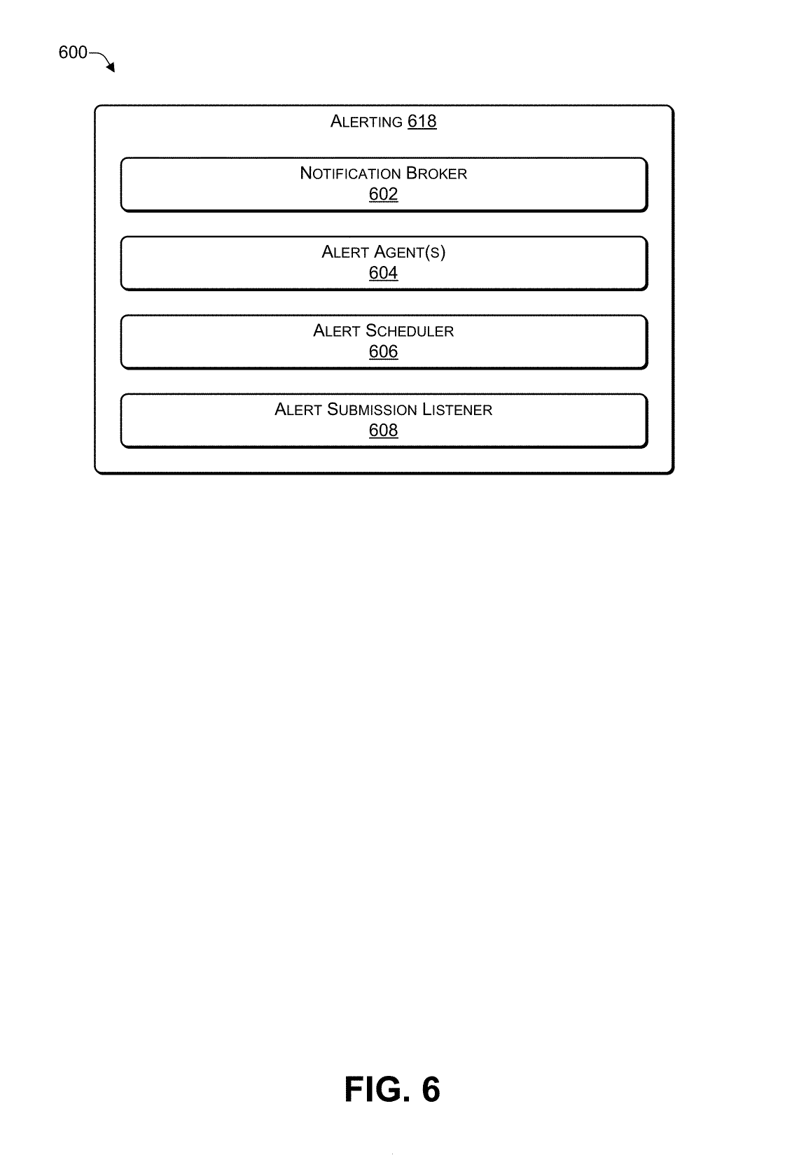

FIG. 6 is a block diagram illustrating a computing system 600 that includes an alerting component according to some examples. The alerting component 618 may include a notification broker 602, one or more alert agents 604, an alert scheduler 606, and alert submission listener 608. The alert submission listener 608 may handle requests (e.g., from the User Interface or API) for the creation, modification, and deletion of alerts. An alert is a notice or warning that some rule, threshold, or other condition has been met. Submissions to alter submissions listener 608 may update the master alerts table read by the alert scheduler.

Alert Definition: Name—internal alert ID, Query/Command to run, Interval/Frequency—How often to check for criteria/How many alerts before silencing, Criteria/Threshold—Number of shipments per hour at store X drops below value Y; Average Response time of Create Order service is greater than Z milliseconds, Alert Plan of Action (APoA)—Set of instructions to take if criteria is met or threshold is breached. Can be to update a specific UI view, send an email to one or more IDs (including distribution groups; hi-priority or normal), page a support team, notify a 3rd-party API, run simple server commands, etc, User scope—Populated if plan of action includes notification; defines which user or user group will receive the notification.

Alert Scheduler—The alert scheduler will read the master alerts table and handles delegation of alert monitoring tasks to the alerting agents. The alert scheduler also handles any timing and wakes up the alert agents as defined in the interval/frequency settings of the alert definition.

Alert Agent(s)—Delegate(s) of the Alert scheduler who run the query and/or commands specified by alert definition on the intended schedule. They will evaluate if the criteria or threshold is met and proceed to take the prescribed plan of action. Alert agents also handle sending notification messages to the notification broker if the alert plan of action includes such a definition. The alert agents run as standalone Java Virtual Machine processes and can be scaled horizontally (different servers) or vertically (same server).

Notification Broker—Specialized proxy process to update the UI views with notifications and to integrate with 3^{rd} party alerting systems. If the Alert Plan of Action specifies that the UI should be updated, a pop-up notification will be shown on the UI view (live if user logged in) as well as a message will be placed in the user's notification inbox (viewable within menu presented to logged in user). Logically, the notification broker sits between the UI controllers and the backend alert agents. The alert agents send a message to the notification broker with the contents of the notification to display to the user. If the Alert Plan of Action specifies that an external system receive the notification, the broker will leverage the matching plugin to communicate with the external system and transfer the notification in a syntax and format understood by the external system. Examples of compatible external systems are HipChat, PagerDuty, Slack, NetCool, and standard Email. Notifications can be delivered to either the UI or external system or both depending on how the alert is defined.

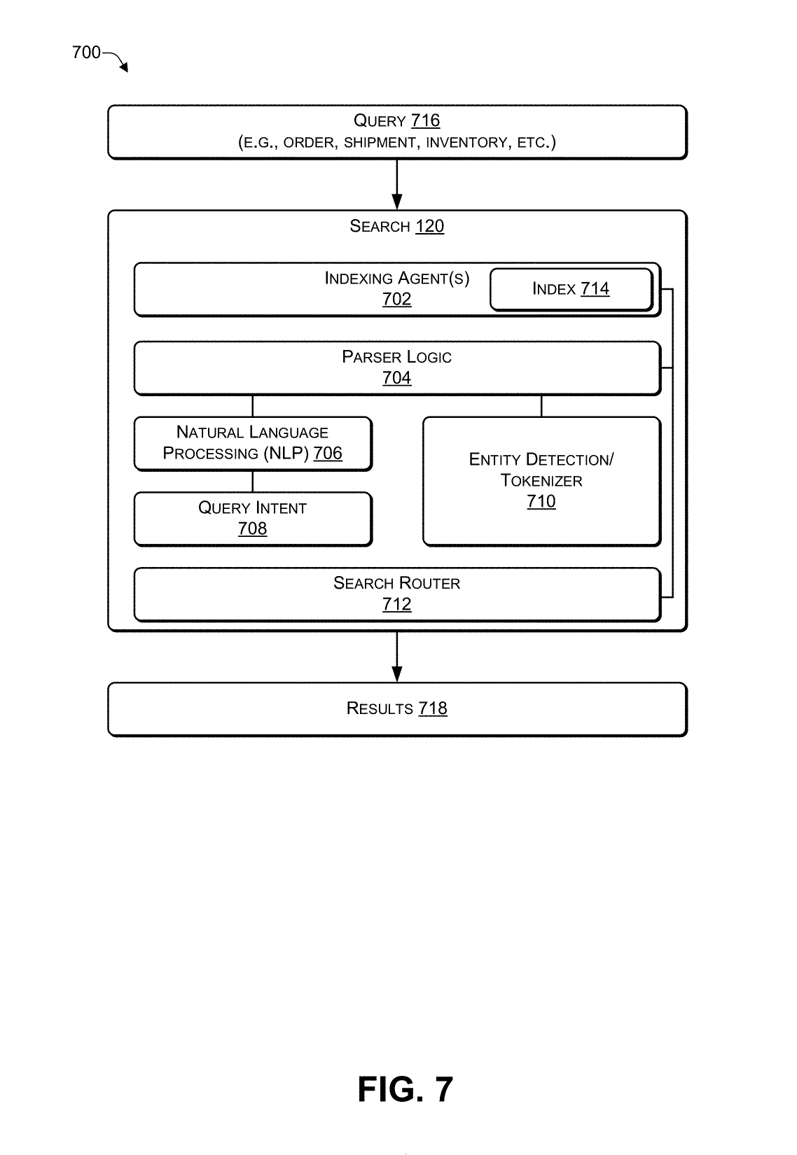

FIG. 7 is a block diagram illustrating a computing system 700 that includes a search component according to some examples. The search component 120 may include one or more indexing agent(s), parser logic 704, a natural language processing (NLP) module 706, a query intent determination module 708, an entity/detection tokenizer 710, and a search router 712. The indexing agent(s) 702 may crawl the data extracted from the order management system and create a searchable index 714.

When a query 716 is submitted to the search component 120, the parser logic 704 may parse the terms included in the query 716. The NLP module 706 may assist in parsing queries that include search terms that use natural language constructs (e.g., “What is the status of order XYZ?” “What are the inventory levels for item ABC at stores 1, 2, and 10?). The NLP module 706 may use the query intent determination module 708 to determine an intent associated with the query 716, e.g., to determine what information the query is intending to request. The entity/detection tokenizer 708 may parse the query 716 to identify entities to be queried and to create a set of tokens for use in a search. For example, a query “how much inventory of X in store Y” may indicate that the store Y is an entity to be queried regarding an inventory level of item X. After the query 716 has been parsed to identify search terms, the search router 712 may route the search terms to one or more components of the BDPS 102 and provide search results 718.

Based on the outcome of semantic deduction, or instructions explicitly provided by the user query 716, the results 718 may be fully or partially combined as a Visualization Plan of Action (VPoA). The VPoA is a serializable JSON data structure that may be sent to the visualization generator 116 which presents the results via the GUI, along with an option to view the constituent parts, or even the original data. Various analytics tools may be applied to the results 718.

The indexing agent 702 may use a pre-defined schedule to check for records in the storage component 122, such as a distributed database management system (e.g., Apache Cassandra™) with a timestamp greater than a previous run (e.g., in which tables to index may be determined by configuration). The indexing agent 702 may first update the indexes (e.g., based on Apache Lucene™) in the distributed database management system before writing new, or updating existing, documents in Elasticsearch. The indexing agent 702 may aggregate a search history to identify most searched terms and update the index 714. The index 714 may be used to provide hints and auto completion for terms in the query 716. For example, the search component 120 may directly access Elasticsearch to leverage the Suggestor and Completion modules. The index 714 may include multiple indexes which the indexing agent 702 creates and updates. The indexing agent 702 may rank terms based on a frequency of usage and assign a weighting to the terms. For example, more frequently used terms may be ranked higher than less frequently used terms.

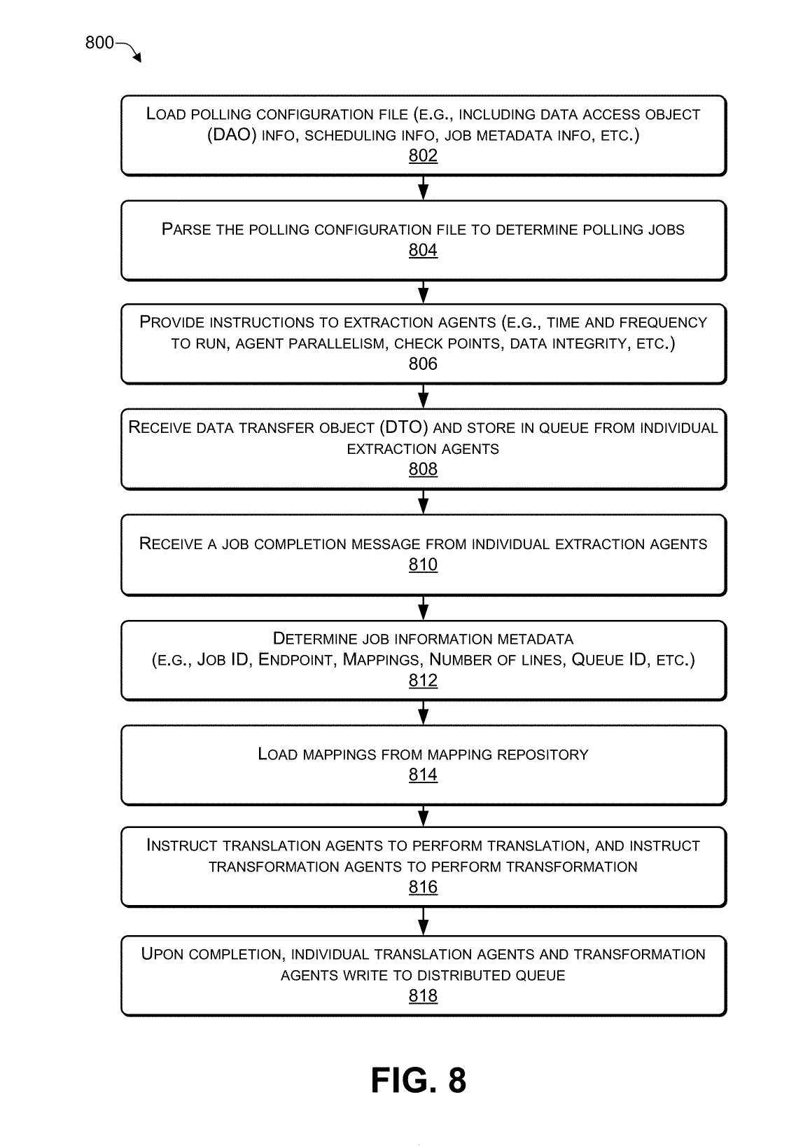

FIG. 8 is a flowchart of a process 800 that includes extracting data from an order management system according to some examples. The process 800 may be performed by one or more components of the BDPS 102 of FIG. 1. The BDPS 102 may extract data from an external system (e.g., the order management system 208 of FIG. 2) by polling (e.g., extracting data at predetermined times), on demand (e.g., in response to a query), or bulk load (loading historical data from an external system).

At 802, a polling configuration file may be loaded. At 804, the polling configuration file may be parsed to determine polling jobs. At 806, instructions to extract data (e.g., from an order management system) may be provided to extraction agents. For example, in FIG. 3, the data extraction coordinator 308 may load a polling configuration file stored on a disk into main memory (e.g., during initial startup or in response to a user instruction). The data extraction coordinator 308 may parse the polling configuration file 318 to determine the polling jobs (e.g., tasks) that are to be performed and assign the polling jobs to the extraction agents 310. For example a first extraction agent may be assigned a first polling job, a second extraction agent may be assigned a second polling job, etc. In some cases, two or more of the extraction agents 310 may operate substantially in parallel to provide consistent information and avoid mismatched data. Each polling job may include information such as a reference to a data access object (DAO), scheduling information (e.g., how often to perform the polling), and job metadata. The DAO is an object that provides an abstract interface to the underlying data store of an external system, such as the order management system 208. By mapping application program interface (API) calls to a persistence layer, the DAO may enable specific data operations without exposing details of a database. The DAO may include data store access instructions (e.g., how to extract the data), access credentials and/or access keys, query information (e.g., how to query the external system), a format associated with the data stored in the external system, etc. The job metadata may identify a transformation mapping to use when transforming the extracted data, a translation mapping to use when translating the extracted data, a topic (e.g., Apache Kafka message topic) to associate with the extracted data, etc. The data extraction coordinator 308 may, based on parsing the polling configuration file 318, determine the polling jobs (e.g., tasks) that are to be performed and pass instructions associated with each polling job to the extraction agents 310. The instructions the data extraction coordinator 308 provides to the extraction agents 310 may include when to perform the polling (e.g., data extraction), how often to perform the polling, DAO information (e.g., instructions on how to access the data), which agents are to be performed substantially in parallel (e.g., to extract consistent data), checkpoints and data integrity control, etc. The parallelism between agents may be done by avoiding extraction of inconsistent data, e.g., to avoid having one agent determine an inventory level of a particular item at a location and then having another agent later determine how many of the particular item were shipped from the location.

At 808, a data transfer object may be received from at least one of the extraction agents and stored in a queue. At 810, a job completion message may be received from at least one of the extraction agents. For example, in FIG. 3, the extraction agents 310 may query the data store and the results may be encapsulated (e.g., effectively serialized) into a data transfer object (DTO) that is stored in an in-memory queue. After each of the extraction agents 310 have completed their assigned job, each of the extraction agents 310 may send a job completion report (e.g., job metadata) to the data extraction coordinator 308. The job completion report may indicate whether the data extraction was successful, how much data was extracted etc. If the data extraction was unsuccessful (or partially unsuccessful), the job completion report may indicate the type of error(s) that were encountered, error messages received from the external system, etc.

At 812, job information metadata may be determined. For example, in FIG. 3, the data extraction coordinator 308 may pass job information metadata 320 to the data transformation coordinator 402. The job information metadata 320 may include a job identifier (e.g., which polling job was performed), an endpoint, transformation mapping, translation mapping, number of lines (e.g., how much data was extracted), a queue identifier (e.g., identifying where in the queue the extracted data was stored), etc. The job information metadata 320 may thus specify which mappings from the mapping repository 414 to use when translating and/or transforming the extracted data 322.

An endpoint identifies where to send the resulting dataset of the job upon completion. For example, the on demand job submitted by a user from the UI may be a request to load 1 years worth of history of the inventory picture for Item X at Store Y. The primary purpose of the job server is to handle user requests for long time ranges of data to be loaded from the internal BDPS data store. The job server may thus operate asynchronous (except that the job server pulls from already aggregated BDPS data store versus the on demand data extraction which pulls from the Order management DB or other event driven external source). Possible endpoints could be the internal BDPS data store (e.g. Apache Cassandra), the internal BDPS cache (e.g. Elasticsearch), the internal BDPS data lake (e.g. Hadoop), any other internal BDPS agent or service via API, any external 3rd part web service via API, e-mail, or simply to the UI screen in an ephemeral context (lasting only the duration of the user's current session, temporary).

At 814, one or more mappings may be loaded from a mapping repository. At 816, translation agents may be instructed to translate extracted data and transformed agents may be instructed to transform extracted data. At 818, one or more of the translation agents may, after translating the extracted data to create translated data, write the translated data to a distributed queue and one or more of the transformation agents may, after transforming the extracted data to create transformed data, write the transformed data to the distributed queue. For example, in FIG. 4, the data transformation coordinator 402 may load one or more of the mappings 416(1) to 416(M) from the mapping repository 414 based on the mappings identified in the metadata 320. The mappings 416 may include extensible stylesheet language transformations (XLST) mappings, Apache Avro™ mappings, JavaScript Object Notation (JSON) mappings, extensible markup language (XML) mappings, etc. XSLT is a language for transforming XML documents into other XML documents, or other formats such as HTML for web pages, plain text or into XSL Formatting Objects, which may subsequently be converted to other formats, such as portable document format (PDF), PostScript, portable network graphics (PNG), etc. Avro™ is a remote procedure call and data serialization framework that uses JSON for defining data types and protocols, and serializes data in a compact binary format. Avro™ may provide both a serialization format for persistent data and a wire format for communication BDPS agents and services and through the distributed Kafka queue backbone. The data transformation coordinator 402 may instruct the translation agents 404 and the transformer agents 406 to apply the appropriate mappings 416 to create the translated data 410 and the transformed data 412. Upon completion of the translation or transformation, the agents 404, 406 may send a message, e.g., write out to a particular Kafka Topic, to a persistent data store.

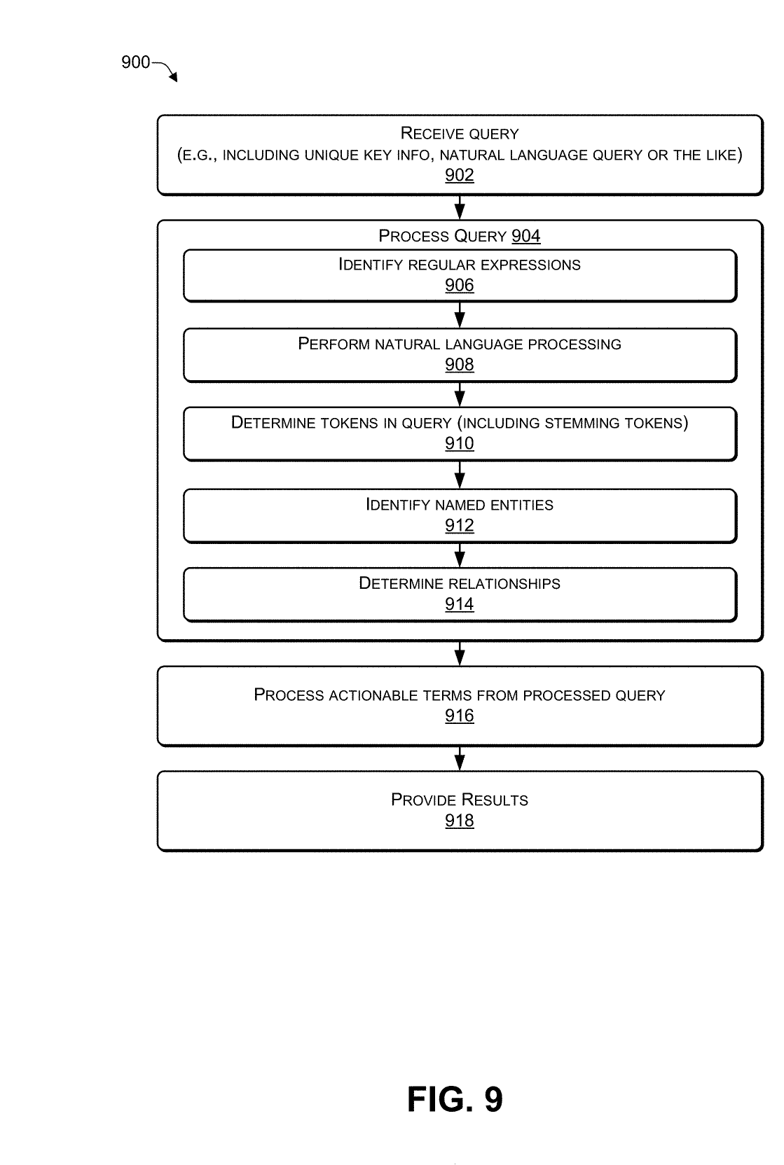

FIG. 9 is a flowchart of a process 900 that includes receiving a query according to some examples. The process 900 may be performed by the search component 120 of FIG. 1. The search component 120 may include the ability to automatically detect unique identifiers, such as order numbers, order line keys, shipment numbers, inventory items, purchase order numbers, return identifiers, and stock keeping units (SKUs). The search component 120 may include the NLP module 706 and the query intent determination module 796 to enable users to describe what information the users are searching for and to receive, substantially in real-time, data and visualizations.

At 902, a query may be received. For example, in FIG. 7, the search component 120 may receive the query 716 that includes (1) one or more unique keys, e.g., definitive numbers such as an order number, a shipment number, an item number, etc. and (2) natural language search terms, e.g., open ended search terms. The NLP module 706 may provide hints and auto-completion for the natural language search terms.

At 904, the search component 120 may process the query. For example, at 906, the query may be processed to identify regular expressions (e.g., regex) before the query is routed to the search router 712. The regex matching may determine whether the query includes a regular expression by performing a pattern lookup of identifier (ID) formats known to be associated with the Order Management System 208. If a known ID format is matched, then a request is made to a search engine, such as Elasticsearch, and a JSON representation of the document(s) may be returned to the search router 712. The search router 712 may extract data in the JSON representation of the document(s) into a tabular format and provide the results 718 to the user.

At 908, natural language processing may be performed. For example, in FIG. 7, if the parser logic 704 determines that the query 716 includes natural language terms, then the NLP module 706 and the query intent module 708 may be used to determine the query intent of the query 716.

At 910, the query may be parsed to determine tokens in the query. For example, in FIG. 7, the entity detection/tokenizer 710 may parse the query 716 to identify tokens based on delimiters, logical grammar, and intention grouping. In some cases, the tokens may be stemmed by reducing inflected or derived words to a stem word (e.g., a root word).

At 912, named entities may be identified. For example, in FIG. 7, the entity detection/tokenizer 710 may identify and classify tokens into predefined entities such as identifiers used by the order management system 208, transaction types, visualization types and formats, statistics, dates and times, etc.

At 914, relationship information may be determined. For example, identifiers and transaction types associated with the order management system 208 may be mapped to intended visualizations, e.g., a first type of information (e.g., inventory) may be displayed using a first type of chart (e.g., pie chart, line chart), a second type of information (e.g., order information) may be displayed using a second type of chart (e.g., bar chart, area chart), etc.

At 916, actionable terms from the processed query may be processed. At 918, results may be provided. For example, in FIG. 7, after actionable terms in the query 716 have been identified, the actions may be grouped into chunks and the appropriate actions may be performed for each chunk, and the results 718 may be provided (e.g., displayed) to the user. The actionable chunks may be processed by the parser logic 704 substantially in parallel (e.g., using separate threads) by spawning queries to retrieve the data corresponding to each chunk. For example, load details of Order XYZ, load volume metrics of Transaction Type ABC from the previous 2 weeks, load the order creation response time for Order XYZ, load line 1 of shipment details for Order XYZ, etc.

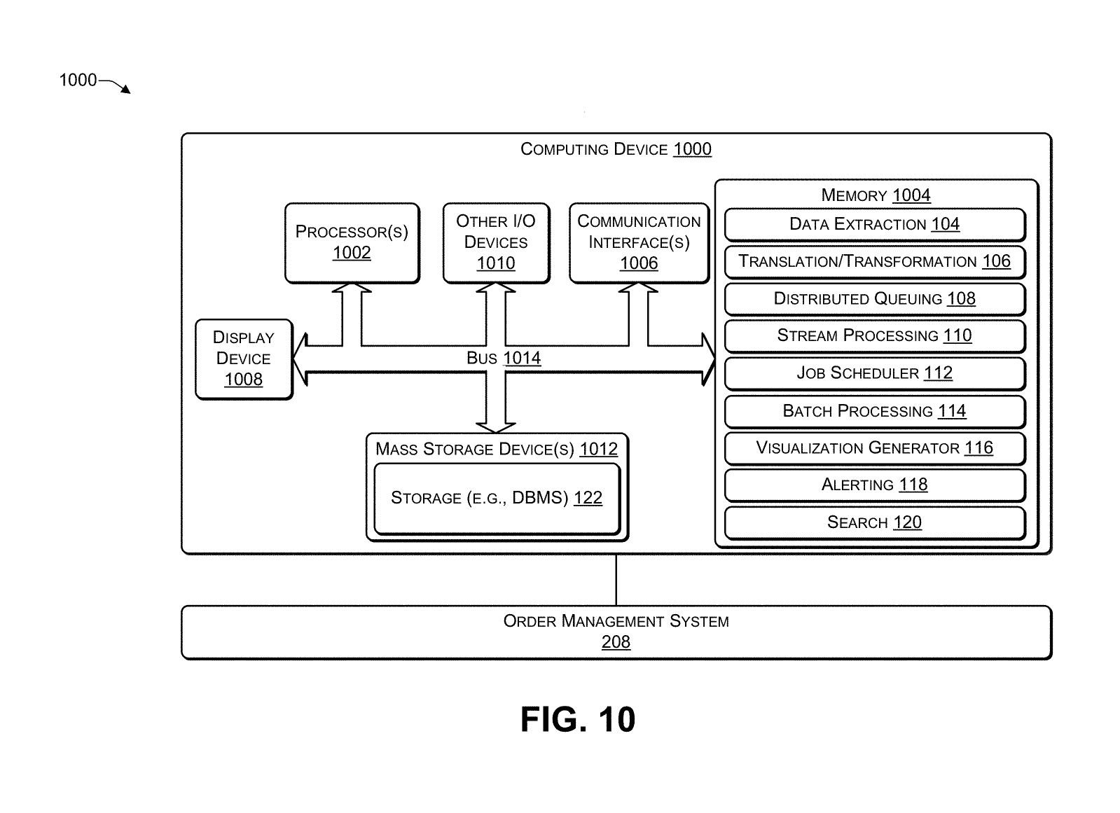

FIG. 10 illustrates an example configuration of a computing device 1000 (e.g., server) that can be used to implement the systems and techniques described herein, such as the BDPS 102 of FIGS. 1-3. The computing device 1000 may include one or more processors 1002, a memory 1004, communication interfaces 1006, a display device 1008, other input/output (I/O) devices 1010, and one or more mass storage devices 1012, configured to communicate with each other, such as via a system bus 1014 or other suitable connection.

The processor 1002 is a hardware device (e.g., an integrated circuit) that may include one or more processing units, at least some of which may include single or multiple computing units or multiple cores. The processor 1002 can be implemented as one or more hardware devices, such as microprocessors, microcomputers, microcontrollers, digital signal processors, central processing units, state machines, logic circuitries, and/or any devices that manipulate signals based on executing operational instructions. Among other capabilities, the processor 1002 can be configured to fetch and execute computer-readable instructions stored in the memory 1004, mass storage devices 1012, or other computer-readable media.

Memory 1004 and mass storage devices 1012 are examples of computer storage media (e.g., memory storage devices) for storing instructions which are executed by the processor 1002 to perform the various functions described above. For example, memory 1004 may generally include both volatile memory and non-volatile memory (e.g., RAM, ROM, or the like) devices. Further, mass storage devices 1012 may include hard disk drives, solid-state drives, removable media, including external and removable drives, memory cards, flash memory, floppy disks, optical disks (e.g., CD, DVD), a storage array, a network attached storage, a storage area network, or the like. Both memory 1004 and mass storage devices 1012 may be collectively referred to as memory or computer storage media herein, and may be a media capable of storing computer-readable, processor-executable program instructions as computer program code that can be executed by the processor 1002 as a particular machine configured for carrying out the operations and functions described in the implementations herein.

The computing device 1000 may also include one or more communication interfaces 1006 for exchanging data (e.g., via one or more networks). The communication interfaces 1006 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet, and the like. Communication interfaces 1006 can also provide communication with external storage (not shown), such as in a storage array, network attached storage, storage area network, or the like.

A display device 1008, such as a monitor may be included in some implementations for displaying information and images to users. Other I/O devices 1010 may be devices that receive various inputs from a user and provide various outputs to the user, and may include a keyboard, a remote controller, a mouse, a printer, audio input/output devices, and so forth.

The computer storage media, such as memory 1004 and mass storage devices 1012, may be used to store software and data. For example, the computer storage media may be used to store software components (e.g., modules), such as the data extraction component 104, the translation/transformation component 106, the distributed queueing component 108, the stream processing component 110, the job scheduler component 112, the batch processing component 114, the visualization generator 116, the alerting component 118, the search module 120, and the storage (e.g., DBMS) 122.

The computing device 1000 may be used to execute the components/modules 104, 106, 108, 110, 112, 114, 116, 118, 120, and 122 to extract data periodically, extract data on-demand, and bulk load historical data from an external system, such as the order management system 208. The extracted data may be processed (e.g., translated and/or transformed) by the translation/transformation component 106. The transformed data and the translated data may be stored in the storage 122. The visualization generator 116 may enable a user to display different views of the extracted data that has been transformed and/or translated.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, and can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as Java, C++, Perl, or other, a low-level programming code such as machine code, etc. An example software module is a basic input/output system (BIOS) file. A software module may include an application programming interface (API), RESTful web service (REST) implementation, a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various examples of the method and apparatus of the present disclosure have been illustrated herein in the Drawings and described in the Detailed Description, it will be understood that the disclosure is not limited to the examples disclosed, and is capable of numerous rearrangements, modifications and substitutions without departing from the scope of the present disclosure.

What is claimed is:

1. A computer-implemented method, comprising:
loading, by a data extraction coordinator, a polling configuration file;
parsing, by the data extraction coordinator, the polling configuration file to identify a plurality of polling jobs;
assigning, by a data extraction coordinator, an individual polling job of the plurality of polling jobs to an extraction agent of a plurality of extraction agents;
querying, by the extraction agent, an external data store to retrieve extracted data;
storing the extracted data in a distributed publish/subscribe architecture queue as a data transfer object;
receiving a message from the extraction agent that the individual polling job has been completed;
sending, by the data extraction coordinator, job metadata associated with the individual polling job to a transformation coordinator;
loading, by the transformation coordinator, a mapping from a mapping repository;
providing, by the transformation coordinator, instructions to a transformation agent to apply the mapping to the extracted data to create transformed data; and
displaying the transformed data in a user interface, the transformed data displayed according to an associated display template.

2. The computer-implemented method of claim 1, wherein the polling configuration file is loaded by the data extraction coordinator during initial execution of the data extraction coordinator.

3. The computer-implemented method of claim 1, wherein an individual polling job of the plurality of polling jobs includes:
a reference to a data access object;
scheduling information; and
job metadata.

4. The computer-implemented method of claim 3, wherein the data access object includes:
instructions associated with accessing an external data store;
at least one access credential or access key used to access the external data store;
a query format used to access the external data store; and
an extraction format.

5. The computer-implemented method of claim 3, wherein the job metadata specifies:
a mapping to apply to the extracted data; and
a message topic in a distributed queue associated with the individual polling job.

6. The computer-implemented method of claim 1, further comprising:
providing, by the data extraction coordinator, extraction instructions to the extraction agent, the extraction instructions including:
a time of day at which to initiate accessing the external data store;
a frequency with which to access the external data store; and
data integrity control information.

7. The computer-implemented method of claim 6, wherein the extraction instructions include:
a parallel extraction instruction instructing the extraction agent to access the external data store substantially in parallel with one or more additional extraction agents.

8. The computer-implemented method of claim 1, wherein the job metadata includes:
a job identifier associated with the individual polling job;
at least one of a transformation mapping or a translation mapping to be applied to the extracted data; and
a queue topic and message identifier associated with the extracted data stored in the queue.

9. The computer-implemented method of claim 1, wherein the mapping includes at least one of an:
extensible stylesheet language transformation (XSLT);
a Java Script Object Notation (JSON) transformation; or
an extended markup language (XML) transformation.

10. One or more non-transitory computer-readable media storing instructions that are executable by one or more processors to perform operations comprising:
loading, by a data extraction coordinator, a polling configuration file;
parsing, by the data extraction coordinator, the polling configuration file to identify a plurality of polling jobs;
assigning, by a data extraction coordinator, an individual polling job of the plurality of polling jobs to an extraction agent of a plurality of extraction agents;
querying, by the extraction agent, an external data store to retrieve extracted data;
storing the extracted data in a distributed queue topic message as a data transfer object;
receiving a message from the extraction agent that the individual polling job has been completed;
sending, by the data extraction coordinator, job metadata associated with the individual polling job to a transformation coordinator;
loading, by the transformation coordinator, a mapping from a mapping repository;
providing, by the transformation coordinator, instructions to a transformation agent to apply the mapping to the extracted data to create transformed data; and
displaying the transformed data in a graphical user interface, the transformed data displayed according to an associated display template.

11. The one or more non-transitory computer-readable media of claim 10, the operations further comprising:
displaying, by the graphical user interface, one or more data extraction presets.

12. The one or more non-transitory computer-readable media of claim 11, wherein the one or more data extraction presets includes a bulk load preset to load historical data that is at least one month old.

13. The one or more non-transitory computer-readable media of claim 10, the operations further comprising:
receiving, by the graphical user interface, a user selection to create a new data extraction preset;
creating the new data extraction preset comprising:
a data access object;
a structured query language (SQL) query or an extraction command to extract user-specified data;
at least one of a translation schema or a transformation schema to modify the user-specified data after extraction;
an output format in which to output the user-specified data;
a time at which to extract the user-specified data; and
a frequency with which to extract the user-specified data.

14. The one or more non-transitory computer-readable media of claim 13, wherein the data access object includes:
at least one of a protocol or a driver to extract user-specified data;
a location from which to extract the user-specified data;
one or more credentials to use to extract the user-specified data; and
a schema associated with the user-specified data.

15. A server comprising:
one or more processors; and
one or more non-transitory computer-readable media storing instructions that are executable by the one or more processors to perform operations comprising:
loading a polling configuration file;
parsing the polling configuration file to identify a plurality of polling jobs;
assigning an individual polling job of the plurality of polling jobs to an extraction agent of a plurality of extraction agents;
querying, by the extraction agent, an external data store to retrieve extracted data;
storing, by the extraction agent, the extracted data in a queue as a data transfer object;
indicating, by the extraction agent, that the individual polling job has been completed;
determining job metadata associated with the individual polling job;
loading a mapping from a mapping repository based on the job metadata;
applying the mapping to the extracted data to create transformed data; and
displaying the transformed data in a user interface, the transformed data displayed according to an associated display template.

16. The server of claim 15, wherein the polling configuration file is loaded in response to a user instruction.

17. The server of claim 15, wherein an individual polling job of the plurality of polling jobs includes:
a reference to a data access object;
scheduling information; and
job metadata.

18. The server of claim 17, wherein:
the data access object includes:
instructions associated with accessing an external data store;
at least one access credential or access key used to access the external data store;
a query format used to access the external data store; and
an extraction format; and
the job metadata includes:
a mapping to apply to the extracted data; and
a message topic associated with the individual polling job.

19. The server of claim 15, where in querying the external data store to retrieve the extracted data is performed at a particular time of day at a particular frequency.

20. The server of claim 15, the operations further comprising:
receiving, by the user interface, a user selection to create a new data extraction preset;
creating the new data extraction preset comprising:
a data access object;
a structured query language (SQL) query or an extraction command to extract user-specified data;
at least one of a translation schema or a transformation schema to modify the user-specified data after extraction;
an output format in which to output the user-specified data;
a time at which to extract the user-specified data; and
a frequency with which to extract the user-specified data.
